(19) United States
(12) Patent Application Publication
(10) Pub. No.: US 2026/0134035 A1
(43) Pub. Date: May 14, 2026

(54) DEVICE, DATA STRUCTURE AND COMPUTER-IMPLEMENTED METHOD FOR CONSTRUCTING A TRIPLE OF A KNOWLEDGE GRAPH

(71) Applicant: Robert Bosch GmbH, Stuttgart (DE)

(72) Inventors: Cuong Xuan Chu, Heilbronn (DE); Manuel Fischer, Bad Rappenau (DE); Marvin Schiller, Heimsheim (DE); Mohamed Gad-Elrab, Saarbruecken (DE); Trung Kien Tran, Stuttgart (DE)

(21) Appl. No.: 19/385,705

(22) Filed: Nov. 11, 2025

(30) Foreign Application Priority Data
Nov. 13, 2024 (DE) 10 2024 210 902.9

(51) Int. Cl. G06F 16/901

(52) U.S. Cl. CPC G06F 16/9024

(57) ABSTRACT

A device, a data structure, and a computer implemented method for constructing a triple of a knowledge graph. The method includes providing input data, wherein the input data comprises an item, and a property of the item, and a header for the item, and a header for the property of the item; determining depending on the input data, a semantic description of the headers; determining depending on the semantic description, an ontology defining a property for the header of the property of the item; determining depending on the semantic description and the ontology, a mapping specification, wherein the mapping specification defines a relation between the header for the item, and the header for the property of the item; constructing, depending on the mapping specification and the input data, the triple including the relation between the item and the property.

### CROSS REFERENCE

The present application claims the benefit under 35 U.S.C. § 119 of Germany Patent Application No. DE 10 2024 210 902.9 filed on Nov. 13, 2024, which is expressly incorporated herein by reference in its entirety.

### BACKGROUND INFORMATION

The present invention relates to a device, a data structure, and a computer-implemented method for constructing a triple of a knowledge graph.

### SUMMARY

The present invention provides a computer implemented method for constructing a triple of a knowledge graph. According to an example embodiment of the present invention, the method includes providing input data, wherein the input data comprises an item, and a property of the item, and a header for the item, and a header for the property of the item, wherein the method comprises determining depending on the input data, a semantic description of the headers, determining depending on the semantic description, an ontology defining a property for the header of the property of the item, determining depending on the semantic description and the ontology, a mapping specification, wherein the mapping specification defines a relation between the header for the item, and the header for the property of the item, and wherein the method comprises constructing, depending on the mapping specification and the input data, the triple comprising the relation between the item and the property, and wherein the method comprises at least one of determining the semantic description by prompting a first large language model to output an output semantically describing the input data, prompting in particular a human expert or a machine automated validation to review the output semantically describing the input data, receiving a result of the review of the output semantically describing the input data, and determining the semantic description depending on the output semantically describing the input data and the result of the review of the output semantically describing the input data, and of determining the ontology by prompting the first or a second large language model to output an output ontologically describing the semantic description, prompting in particular a human expert or a machine automated validation, to review the output ontologically describing the semantic description, receiving a result of the review of the output ontologically describing the semantic description, and determining the ontology depending on the output ontologically describing the semantic description and the result of the review of the output ontologically describing the semantic description, and of determining the mapping specification by prompting the first or the second or a third large language model to output an output mapping for the semantic description and the ontology, prompting in particular a human expert or a machine automated validation, to review the output mapping, receiving a result of the review or the output mapping, and determining the ontology depending on the output mapping and the result of the review of the output mapping.

The method automates the construction of the knowledge graph with instructions from a human expert or with machine automated validation for syntax completeness and consistency without instructions from a human expert.

According to an example embodiment of the present invention, the method proceeds step-wise through several work steps of knowledge graph construction. An example sequence of steps is: determining a semantic description, determining an ontology, determining a mapping, executing the mapping. At each step, an user, e.g., the human expert, or the machine automated validation may review and/or revise the intermediate results, i.e., the semantic description, the ontology, the mapping, to refine the large language model's output. The user may provide additional input, for example, an existing ontology as an input based on which the method constructs a new, extended ontology.

According to an example embodiment of the present invention, the knowledge graph may comprise complex and heterogeneous data. The knowledge graph is based on semantic technologies, i.e., the knowledge graph describes the data unambiguously and in a semantic language that is interpretable by people and by machines. The semantic language may be standardized. The knowledge graph supports interoperability and knowledge sharing. The knowledge graph is configured for the storage and discovery of highly linked data. The knowledge graph supports multi-hop reasoning.

The method is based on formal languages and semantics. The ontology is based for example on an ontology language, e.g., a Web Ontology Language, OWL.

The mapping specification is based for example on the RDF mapping language RML built on the W3C standard RDF (Resource Description Framework).

The semantic description and/or the mapping specification may be based on a constraint language, e.g., Shapes Constraint Language, SHACL.

The knowledge graph comprises knowledge graph data. A validation task may be carried out on the knowledge graph data. The validation task may comprise a completeness check and/or a consistency check, and/or a verification of standards compliance. The knowledge graph provides a basis for retrieval, discovery and analysis of complex data and enable data analytics and decision making in application fields such as finance, supply chain management, health, biotechnology.

The general advantage of employing the large language model in the work steps of knowledge graph construction is that (skilled) human experts require considerable time and effort, which can be minimized when taken over by the provided method of the present invention.

The mapping is a machine-readable intermediate work result that reduces the complexity of applying automatic verification and validation for the completeness and correctness of the produced graph.

The exploitation of the ontology supports producing better results for specialized domains, e.g., manufacturing. The method may make use of previously existing ontologies and an expert's input, which may further enhance the suitability of the constructed knowledge graph for a specific application.

According to an example embodiment of the present invention, providing the input data may comprise providing a table comprising columns and rows, wherein the header for the item identifies the column comprising the item, wherein the header for the property identifies the column comprising the property, wherein the table comprises the item and the property in the same row.

Determining the semantic description of the headers may comprise determining a structured output associating the header of the item with a description of the item, a semantics of the item, and a data type of the item, and determining a structured output associating the header of the property with a description of the property, a semantics of the property, and a datatype of the property.

According to an example embodiment of the present invention, determining the ontology may comprise determining the property for the header of the property of the item to comprise the header of the property of the item as label of the property for the header of the property of the item.

According to an example embodiment of the present invention, determining the mapping specification defining the relation between the header for the item and the header for the property of the item may comprise providing a first mapping for determining a subject of the triple, wherein the first mapping comprises a template comprising the header of the item, providing a second mapping for determining a predicate and an object of the triple, wherein the second mapping comprises the relation, and a template comprising the header of the property of the item.

According to an example embodiment of the present invention, constructing the triple may comprise providing the item as the subject of the triple, providing the relation as the predicate of the triple, and determining the object of the triple by finding the first mapping depending on the header of the item, finding the second mapping depending on the relation, and finding the property of the item as the object depending on the second mapping as defined by the mapping specification.

According to an example embodiment of the present invention, the method may comprise providing properties that are associated with the header of the property of the item and wherein the properties comprise the property of the item, providing properties that are associated with a different header, and wherein finding the property of the item as the object depending on the second mapping comprises determining an instruction to find the properties that are associated with the header of the property of the item depending on the second mapping, in particular to search the property of the item only in the properties that are associated with the header of the property of the item in the second mapping.

According to an example embodiment of the present invention, determining the ontology may comprise determining a class definition comprising a label for the class, and determining the property for the header of the property of the item to comprise the label for the class.

According to an example embodiment of the present invention, determining the ontology may comprise determining the property for the header of the property of the item to comprise a range and a datatype of the second property.

The step-wise method allows for better scaling to large datasets. The intermediate results may be shared, inspected, and potentially re-written, e.g., using the large language model or another large language model. This fosters efficiency, e.g., better scaling, reduction of cost, when dealing with complex data.

The method may comprise instructing the large language model to produce a mapping for the triple instead of instructing the large language model to directly convert all data to triples. Using a mapping allows for easy scaling of the construction of knowledge graphs while minimizing the cost, e.g., there is no need to send complete datasets to the large language model, which is expensive and inefficient.

The method may comprise validating the knowledge graph comprising the constructed triple, and constructing another triple of the knowledge graph depending on the input, the ontology, the semantic description, and the mapping specification determined when constructing the constructed triple, upon successfully validating the knowledge graph, and removing the constructed triple and the ontology, and the semantic description, and the mapping specification determined for the constructed triple before determining another triple depending on the input otherwise.

The produced mapping may be used with the input or with new data having the same structure as the data that was used to produce the mapping without the need to re-use the large language model. In particular, the new data subsequently read with the mapping may contain sensitive protected data that with the method does not need to be sent to a large language model.

The method may comprise constructing another triple of the knowledge graph depending on another input, and the ontology, the semantic description, and the mapping specification determined when constructing the constructed triple, or determining a plurality of triples depending on the mapping specification. Constructing triples from the existing mappings reduces the time for the knowledge graph construction and improves scalability.

According to an example embodiment of the present invention, a device is provided for constructing a triple of a knowledge graph, wherein the device comprises at least one processor and at least one memory, wherein the at least one memory stores instructions executable by the at least one processor that, when executed by the at least one processor, cause the device to execute the method.

A computer program for constructing a triple of a knowledge graph wherein the computer program comprises computer readable instructions that, when executed by the computer, cause the computer to execute the method of the present invention.

A data structure for constructing a triple of a knowledge graph wherein the data structure comprises at least one data field for input data, wherein the input data comprises an item, and a property of the item, and a header for the item, and a header for the property of the item, wherein the data structure comprises at least one data field for a semantic description of the headers determined, in particular with a large language model, depending on the input data, wherein the data structure comprises at least one data field for an ontology defining a property for the header of the property of the item, the ontology being determined, in particular with a large language model, depending on the semantic description, wherein the data structure comprises at least one data field for a mapping specification, wherein the mapping specification defines a relation between the header for the item, and the header for the property of the item, the mapping specification being determined, in particular with a large language model, depending on the semantic description and the ontology, and wherein the data structure comprises at least one data field for the triple comprising the relation between the item and the property, the triple being constructed, depending on the mapping specification.

Further exemplary embodiments of the present invention are derived from the following description and the figures.

### BRIEF DESCRIPTION OF THE DRAWINGS

FIG. 1 schematically depicts a device for constructing a triple of a knowledge graph, according to an example embodiment of the present invention.

FIG. 2 depicts a flow-chart comprising steps of a method for constructing the triple of the knowledge graph, according to an example embodiment of the present invention.

FIG. 3 schematically depicts a data structure for constructing the triple of the knowledge graph, according to an example embodiment of the present invention.

### DETAILED DESCRIPTION OF EXAMPLE EMBODIMENTS

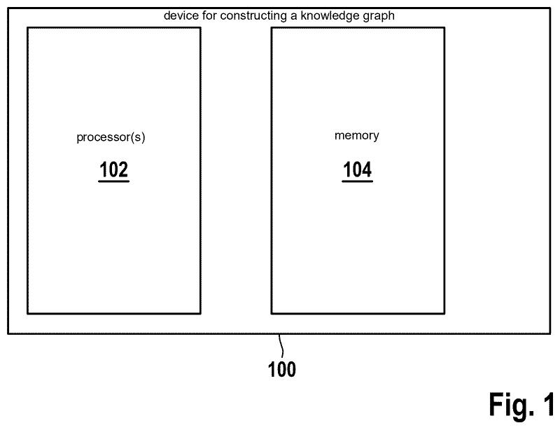

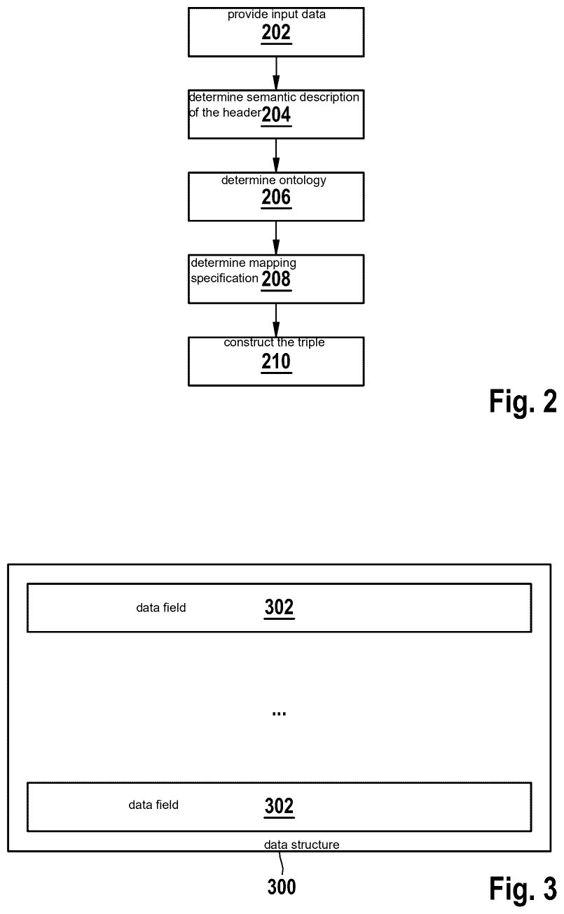

FIG. 1 schematically depicts a device 100 for constructing a triple of a knowledge graph.

A knowledge graph is a collection of facts, also called triples, of the form <subject, predicate, object>. The predicate defines the relation between the subject and the object.

The device 100 comprises at least one processor 102 and at least one memory 104.

The at least one memory 104 stores instructions executable by the at least one processor 102 that, when executed by the at least one processor 102, cause the device 100 to execute a method for constructing the triple of the knowledge graph.

The method is described by way of example of a large language model. The large language model is configured for understanding and summarizing data in several formats. The large language model is configured to be prompted to produce output in specific formats.

The method utilizes these features of the large language model by providing the large language model with input data and a query, the so-called prompt, to extract specific information about the input data in structured format.

An example for the large language model is a generative pre-trained transformer model. Liu, Y., Han, T., Ma, S., Zhang, J., Yang, Y., Tian, J., . . . & Ge, B. (2023); “Summary of ChatGPT-Related Research and Perspective Towards the Future of Large Language Models;” Meta-Radiology, 100017. describes an example for the large language model.

The method is described by way of example of an ontology. An ontology is a formal explicit description of concepts, also called classes, in a domain of discourse, properties, also called relations, of each concept describing various features and attributes of the concept, and restrictions on concepts and properties.

Noy, Natalya F. and McGuinness, Deborah L.; “Ontology Development 101: A Guide to Creating Your First Ontology” describes an example for an ontology.

The method is described by way of example of constructing an exemplary triple. For knowledge graph construction, the triples of the knowledge graph are constructed as described for the exemplary triple.

Knowledge graph construction is a process to construct a knowledge graph from input data that originates from one or from different sources of data, e.g., text, or structured data. Knowledge graph construction is a time-consuming process that requires both understanding of the semantic web technologies and the domain of interest. In an exemplary setting, relational data (tabular data) is collected from different systems and used as input to construct a unified knowledge graph.

Exemplary steps for the knowledge graph construction are:
(1) Creating an ontology for the domain of the input data;
(2) Create a mapping from tabular data to such an ontology,
(3) Populating the knowledge graph with the tabular data via such a mapping.

The method is described by way of example of input data that is provided as a table, i.e. tabular data. The method is applicable alike to input data in some other structured or semi-structured format, e.g., key-value pairs.

The method may use optionally extra textual information about the input data in the prompt.

The method assumes the existence of and access to the large language model.

The method determines a triple comprising a subject, a predicate, and an object.

The method comprises a step 202.

The step 202 comprises providing the input data.

The input data comprises a table.

The table is provided for a class. The table comprises columns and rows.

The columns comprise a respective header in a first row of the table. The other rows of the table correspond to a respective instance of the class.

One column comprises a header of an item in the first row, and an item that is associated with the header of the item in a second row. One column comprises a header of a property of the item in the first row, and the property of the item that is associated with the header of the property of the item in the second row.

According to the example, the item represents the subject, the property of the item represents the object, and the header of the column comprising the property of the item represents the relation.

This means, the header for the item identifies the column comprising the item. The header for the property identifies the column comprising the property. The table comprises the item and the property in the same row.

The table may comprise a plurality of rows for different instances of the class.

The table may comprise a plurality of columns for different properties that comprise a header of the respective property in the first row and the respective property for the respective instance in the other rows.

This means, the input data comprises the item, and the property of the item, and the header for the item, and the header for the property of the item.

This means, the input data comprises properties that are associated with the header of the property of the item. The input data includes the property of the item and properties that are associated with a different header.

According to an example, the table comprises in the first column numbers of production items, and in the second column temperature values as the property. The header for the item is “Production Item”. The header for the property is “Temperature”.

The method comprises a step 204.

The step 204 comprises determining depending on the input data a semantic description of the headers.

According to an example, the semantic description of the headers is determined with the large language model depending on the input data and depending on a prompt, requesting the large language model to output the semantic description of the headers depending on the input data.

Determining the semantic description of the headers may comprise determining a structured output.

According to an example, the structured output associates the header of the item with a description of the item, a semantics of the item, and a datatype of the item.

The large language model is for example requested to output the semantic description as structured output in particular associating the header of the item with the description of the item, the semantics of the item, and the datatype of the item.

According to an example, the structured output associates the header of the property with a description of the property, a semantics of the property, and a datatype of the property.

The large language model is for example requested to output the semantic description as structured output in particular associating the header of the property with the description of the property, the semantics of the property, and the datatype of the property.

Given the input data, e.g., the table, a part of the input data may be sampled and included in a prompt to the large language model to detect the data model and generated the semantic description of the data model. Optionally a textual description of the input data may be provided in the prompt. The prompt is designed to return the structured output in a format defined in the prompt.

For the exemplary table comprising production items and temperatures, the semantic description for example comprises

“Production Item”: {
“description”: “The Number of the production item”
“semantics”: “Number”
“datatype”: “integer”
}
“Temperature”: {
“description”: “The temperature of the production item”
“semantics”: “Temperature”
“datatype”: “integer”
}

The datatype may be different, e.g., “string”.

The step 204 may comprise revising the semantic description.

For example, the step 204 comprises
prompting the large language model to output an output semantically describing the input data,
prompting in particular a human expert or a machine automated validation, to review the output semantically describing the input data,
receiving a result of the review of the output semantically describing the input data, and
determining the semantic description depending on the output semantically describing the input data and the result of the review of the output semantically describing the input data.

The output semantically describing the input data is the semantic description to be revised.

The result of the review may confirm the output semantically describing the input data as the semantic description. The result of the review may comprise changes made in the review to the output semantically describing the input data as the semantic description.

The method comprises a step 206.

The step 206 comprises determining an ontology defining a first property for the header of the item and a second property for the header of the property of the item depending on the semantic description.

According to an example, the ontology is determined with the large language model depending on the semantic description and depending on a prompt, requesting the large language model to output the ontology depending on the semantic description.

According to an example, the first property comprises the header of the item as label of the first property. The large language model is for example requested to output the header of the item as label of the first property.

According to an example, the second property comprises the header of the property of the item as label of the second property. The large language model is for example requested to output the header of the property as label of the second property.

The ontology may comprise a class definition comprising a label for the class. The first property and/or the second property may comprise the label for the class. The large language model may be requested to provide the ontology with the class definition comprising the label for the class. The large language model may be requested to provide the first property and/or the second property to comprise the label for the class.

The first property may comprise a range and a datatype of the first property.

The large language model may be requested to provide the first property with the range and the datatype of the first property. The second property may comprise a range and a datatype of the second property. The large language model may be requested to provide the second property with the range and the datatype of the second property.

According to an example, the semantic description is passed again to the large language model with a prompt to construct an OWL ontology with classes and relations for the data in the semantic description. For more focused ontology creation, a textual description of the usage of the input data may be added to the prompt. The result of this step is an ontology in OWL format.

Since the result from the large language model may be incomplete and/or contain errors, a refinement step, i.e., an ontology refinement, may be executed in a loop. The refinement loop may be repeated until the resulting ontology meets a predetermined criterion.

For the exemplary table comprising production items and temperatures, the ontology for example comprises

```
#Class definition
<Production > rdf:type rdfs:Class ;
  rdfs:label “Production ” .
#Property definition
<Production Item> rdf:type rdf:Property ;
  rdfs:label “ Production Item ”;
  rdfs:domain <Production >;
  rdfs:range xsd:string .
< Temperature > rdf:type rdf:Property ;
  rdfs:label “ Temperature”;
  rdfs:domain <Production >;
  rdfs:range xsd:string .
```

The step 206 may comprise revising the ontology.

For example, the step 206 comprises
prompting the large language model to output an output ontologically describing the semantic description,
prompting, in particular a human expert or a machine automated validation, to review the output ontologically describing the semantic description,
receiving a result of the review of the output ontologically describing the semantic description, and
determining the ontology depending on the output ontologically describing the semantic description and the result of the review of the output ontologically describing the semantic description.

The output ontologically describing the semantic description is the ontology to be revised.

The result of the review may confirm the output ontologically describing the semantic description as the ontology. The result of the review may comprise changes made in the review to the output ontologically describing the semantic description as the ontology.

The method comprises a step 208.

The step 208 comprises determining a mapping specification depending on the semantic description and the ontology.

The mapping specification defines a relation between the header for the item, and the header for the property of the item.

According to an example, the mapping specification is determined with the large language model depending on the semantic description and the ontology and depending on a prompt, requesting the large language model to output the mapping specification depending on the semantic description and the ontology.

The mapping specification comprises for example a first mapping for determining a subject of the triple. The first mapping comprises for example a template comprising the header of the item. The large language model is for example requested to output the first mapping with the template comprising the header of the item.

The mapping specification comprises for example a second mapping for determining a predicate and an object of the triple. The second mapping comprises for example the relation, and a template comprising the header of the property of the item. The large language model is for example requested to output the second mapping with the template comprising the header of the property of the item.

Given the ontology and the semantic description, the large language model may be queried to generate the mapping specification in RDF Mapping Language (RML). RML is described in A. Dimou, M. Vander Sande, P. Colpaert, R. Verborgh, E. Mannens, and R. Van de Walle; “RML: A Generic Language for Integrated RDF Mappings of Heterogeneous Data;” in Proceedings of the 7th Workshop on Linked Data on the Web, volume 1184 of CEUR Workshop Proceedings. CEUR, 2014.

The large language model may be queried to transform the data into a graph following the ontology. The method may comprise automatically checking the produced mapping specification for errors and completeness. The method may comprise a refinement step, i.e., a mapping validation, to guide the large language model to produce a correct mapping specification.

For the exemplary table comprising production items and temperatures, the mapping specification for example comprises

```
rr:subjectMap [
  rr:template “http://example.com/Production/{Production
Item}” ;
  rr:class <Production>]
rr:predicateObjectMap [
  rr:predicate <Temperature>;
  rr:objectMap [ rr: column “Temperature”]
]
```

The step 208 may comprise revising the mapping specification. For example, the step 208 comprises
prompting the large language model to output an output mapping for the semantic description and the ontology,
prompting, in particular a human expert or a machine automated validation, to review the output mapping,
receiving a result of the review or the output mapping, and
determining the ontology depending on the output mapping and the result of the review of the output mapping.

The output mapping for the semantic description and the ontology is the mapping specification to be revised.

The result of the review may confirm the output mapping for the semantic description and the ontology as the mapping specification. The result of the review may comprise changes made in the review to the output mapping for the semantic description and the ontology as the mapping specification.

The method comprises a step 210.

The step 210 comprises constructing the triple comprising the relation between the item and the property depending on the mapping specification.

According to an example, the triple is constructed depending on the mapping specification and the input data and depending on a prompt, requesting the large language model to output the triple depending on the mapping specification and the input data.

According to an example, the item is provided as the subject of the triple.

According to an example, the relation is provided as the predicate of the triple.

According to an example, the object of the triple is determined by finding the first mapping depending on the header of the item, finding the second mapping depending on the relation, and finding the property of the item as the object depending on the second mapping.

For example, for finding the property of the item as the object depending on the second mapping, an instruction is determined to find the properties that are associated with the header of the property of the item depending on the second mapping. The instruction in particular instructs to search the property of the item only in the properties that are associated with the header of the property of the item in the second mapping.

For example, the large language model is requested in particular with the instruction, to find the first mapping depending on the header of the item, find the second mapping depending on the relation, and find the property of the item as the object depending second mapping.

FIG. 3 depicts an exemplary data structure 300 for constructing a triple of a knowledge graph.

The data structure 300 comprises at least one data field 302 for the input data, the semantic description the ontology the mapping specification, and the triple.

What is claimed is:

1. A computer implemented method for constructing a triple of a knowledge graph, the method comprising the following steps:
providing input data, wherein the input data includes an item, and a property of the item, and a header for the item, and a header for the property of the item;
determining depending on the input data, a semantic description of the header for the item and the header for the property of the item;
determining depending on the semantic description, an ontology defining a property for the header of the property of the item;
determining depending on the semantic description and the ontology, a mapping specification, wherein the mapping specification defines a relation between the header for the item, and the header for the property of the item;
constructing, depending on the mapping specification and the input data, the triple including a relation between the item and the property; and
at least one of:
determining the semantic description by prompting a first large language model to output an output semantically describing the input data,
prompting a human expert or a machine automated validation to review the output semantically describing the input data,
receiving a result of a review of the output semantically describing the input data,
determining the semantic description depending on the output semantically describing the input data and a result of the review of the output semantically describing the input data, and of determining the ontology by prompting the first or a second large language model to output an output ontologically describing the semantic description,
prompting the human expert or the machine automated validation to review the output ontologically describing the semantic description,
receiving a result of the review of the output ontologically describing the semantic description, and determining the ontology depending on the output ontologically describing the semantic description and the result of the review of the output ontologically describing the semantic description, and of determining the mapping specification by prompting the first or the second or a third large language model to output an output mapping for the semantic description and the ontology,
prompting the human expert or the machine automated validation, to review the output mapping,
receiving a result of the review of the output mapping or the output mapping,
determining the ontology depending on the output mapping and the result of the review of the output mapping.

2. The method according to claim 1, wherein the providing of the input data includes providing a table including columns and rows, wherein the header for the item identifies the column including the item, wherein the header for the property identifies the column including the property, wherein the table includes the item and the property in the same row.

3. The method according to claim 1, wherein the determining of the semantic description of the headers includes determining a structured output associating the header of the item with a description of the item, a semantics of the item, and a datatype of the item, and determining a structured output associating the header of the property with a description of the property, a semantics of the property, and a datatype of the property.

4. The method according to claim 1, wherein the determining of the ontology includes determining the property for the header of the property of the item to include the header of the property of the item as label of the property for the header of the property of the item.

5. The method according to claim 4, wherein the determining of the mapping specification defining the relation between the header for the item and the header for the property of the item includes providing a first mapping for determining a subject of the triple, wherein the first mapping includes a template including the header of the item, providing a second mapping for determining a predicate and an object of the triple, wherein the second mapping includes the relation, and a template including the header of the property of the item.

6. The method according to claim 5, wherein the constructing of the triple includes providing the item as the subject of the triple, providing the relation as the predicate of the triple, and determining the object of the triple by finding the first mapping depending on the header of the item, finding the second mapping depending on the relation, and finding the property of the item as the object depending on the second mapping as defined by the mapping specification.

7. The method according to claim 6, wherein the method includes providing properties that are associated with the header of the property of the item and wherein the properties include the property of the item, providing properties that are associated with a different header, and wherein finding the property of the item as the object depending on the second mapping includes determining an instruction to find the properties that are associated with the header of the property of the item depending on the second mapping, to search the property of the item only in the properties that are associated with the header of the property of the item in the second mapping.

8. The method according to claim 4, wherein the determining of the ontology includes determining a class definition including a label for the class, and determining the property for the header of the property of the item to include the label for the class.

9. The method according to claim 4, wherein the determining of the ontology includes determining the property for the header of the property of the item to includes a range and a datatype of the second property.

10. The method according to claim 1, wherein the method further comprises validating the knowledge graph including the constructed triple, and constructing another triple of the knowledge graph depending on the input, the ontology, the semantic description, and the mapping specification determined when constructing the constructed triple, upon successfully validing the knowledge graph, and removing the constructed triple and the ontology, and the semantic description, and the mapping specification determined for the constructed triple before determining another triple depending on the input otherwise.

11. The method according to claim 1, wherein the method further comprises: (i) constructing another triple of the knowledge graph depending on another input, and the ontology, the semantic description, and the mapping specification determined when constructing the constructed triple, or (ii) determining a plurality of triples depending on the mapping specification.

12. A device for constructing a triple of a knowledge graph, the device comprising:
at least one processor; and at least one memory, wherein the at least one memory stores instructions executable by the at least one processor that, when executed by the at least one processor, cause the device to execute a method for constructing a triple of a knowledge graph, the method including the following steps:
providing input data, wherein the input data includes an item, and a property of the item, and a header for the item, and a header for the property of the item;
determining depending on the input data, a semantic description of the header for the item and the header for the properoty of the item;
determining depending on the semantic description, an ontology defining a property for the header of the property of the item;
determining depending on the semantic description and the ontology, a mapping specification, wherein the mapping specification defines a relation between the header for the item, and the header for the property of the item;
constructing, depending on the mapping specification and the input data, the triple including a relation between the item and the property; and
at least one of:
determining the semantic description by prompting a first large language model to output an output semantically describing the input data,
prompting a human expert or a machine automated validation to review the output semantically describing the input data,
receiving a result of the review of the output semantically describing the input data,
determining the semantic description depending on the output semantically describing the input data and the result of the review of the output semantically describing the input data, and of determining the ontology by prompting the first or a second large language model to output an output ontologically describing the semantic description,
prompting the human expert or the machine automated validation to review the output ontologically describing the semantic description,
receiving a result of the review of the output ontologically describing the semantic description, and determining the ontology depending on the output ontologically describing the semantic description and the result of the review of the output ontologically describing the semantic description, and of determining the mapping specification by prompting the first or the second or a third large language model to output an output mapping for the semantic description and the ontology,
prompting the human expert or the machine automated validation to review the output mapping,
receiving a result of the review of the output mapping or the output mapping,
determining the ontology depending on the output mapping and the result of the review of the output mapping.

13. A non-transitory computer-readable storage medium on which is stored a computer program for constructing a triple of a knowledge graph, the computer program, when executed by a computer, causing the computer to perform the following steps:
providing input data, wherein the input data includes an item, and a property of the item, and a header for the item, and a header for the property of the item;
determining depending on the input data, a semantic description of the header for the item and the header for the property of the item;
determining depending on the semantic description, an ontology defining a property for the header of the property of the item;
determining depending on the semantic description and the ontology, a mapping specification, wherein the mapping specification defines a relation between the header for the item, and the header for the property of the item;
constructing, depending on the mapping specification and the input data, the triple including a relation between the item and the property; and
at least one of:
determining the semantic description by prompting a first large language model to output an output semantically describing the input data,
prompting a human expert or a machine automated validation to review the output semantically describing the input data,
receiving a result of a review of the output semantically describing the input data,
determining the semantic description depending on the output semantically describing the input data and a result of the review of the output semantically describing the input data, and of determining the ontology by prompting the first or a second large language model to output an output ontologically describing the semantic description,
prompting the human expert or the machine automated validation to review the output ontologically describing the semantic description,
receiving a result of the review of the output ontologically describing the semantic description, and determining the ontology depending on the output ontologically describing the semantic description and the result of the review of the output ontologically describing the semantic description, and of determining the mapping specification by prompting the first or the second or a third large language model to output an output mapping for the semantic description and the ontology,
prompting the human expert or the machine automated validation, to review the output mapping,
receiving a result of the review of the output mapping or the output mapping,
determining the ontology depending on the output mapping and the result of the review of the output mapping.
